(19) United States
(12) Patent Application Publication
(10) Pub. No.: US 2005/0038846 A1
(43) Pub. Date: Feb. 17, 2005

(54) Substraction circuit with a dummy digital to analog converter

(76) Inventors: Don C. Devendorf, Carlsbad, CA (US); Benjamin Felder II, Rancho Palos Verdes, CA (US); Erick M. Hirata, Torrance, CA (US); Christopher B. Langit, Gardena, CA (US); Lloyd F. Linder, Agoura Hills, CA (US)

Correspondence Address: David T. Yang, Esq.;Morrison & Foerster LLP, Suite 3500, 555 West Fifth Street, Los Angeles, CA, 90013-1024, US

(21) Appl. No.: 10/847,433

(22) Filed: May 17, 2004

Related U.S. Application Data
(60) Provisional application No. 60/495,765, filed on Aug. 14, 2003.

(51) Int. Cl. G06G 7/00

(52) U.S. Cl. 708/801

(57) ABSTRACT

A subtraction circuit. The novel subtraction circuit includes a first circuit for providing an impedance between an input node and an output node, a second circuit for generating a first current and applying the first current to the output node to produce a desired voltage drop between the input and output nodes, and a third circuit for independently generating a second current relative to the first current and applying the second current to the input node to regulate a current input to the first circuit at the input node. The second and third circuits are implemented using two digital to analog converters (DACs), a precision DAC for generating the first current and a non-trimmed “dummy” DAC for generating the second current. In an illustrative embodiment, the subtraction circuit is used in the reconstruction stage of a subranging analog to digital converter.

### CROSS-REFERENCE TO RELATED APPLICATIONS

This application claims the benefit of U.S. Provisional Application No. 60/495,765, filed Aug. 14, 2003, the disclosure of which is hereby incorporated by reference.

### BACKGROUND OF THE INVENTION

1. Field of the Invention

The present invention relates to electronics. More specifically, the present invention relates to analog to digital converters.

2. Description of the Related Art:

Analog to digital converters are widely used for converting analog signals to corresponding digital signals for many electronic circuits. For example, a high resolution, high-speed analog to digital converter (ADC) may find application in the cellular infrastructure market, broadband communications, video circuits, radar, and electronic warfare applications. In the field of analog to digital conversion, there continue to be many driving goals, such as speed, increased number of bits (relating to dynamic range and spur-free operation), power consumption, and size. Two of the most critical specifications remain speed and dynamic range.

The fastest ADC architecture is called “flash” conversion. A flash ADC produces an N-bit digital output in one step using a comparator bank comprised of 2^{N}/1 parallel comparators. This architecture, however, is limited in dynamic range to about 8 bits, since the number of comparators grows rapidly as the number of bits N becomes larger. The next fastest converter technique is a subranging pipelined architecture.

Subranging ADCs typically use a low resolution flash quantizer during a first stage or “coarse pass” to convert an analog input signal into the most significant bits (MSB) of its digital value. An analog version of the MSB word, generated by a digital to analog converter (DAC), is then subtracted from the input signal at a summing node to produce a residue or residual signal. The residue signal is subsequently digitized by one or more additional stages or “fine passes” to produce the least significant bits (LSB) of the input signal. The digital words produced by each stage are combined by digital error correcting circuitry to produce a digital output representing the original analog input signal.

For high speed, large dynamic range ADCs, it is often necessary to drive the first, and often other, stages of a subranging converter with a sample and hold (S/H) circuit. The S/H circuit samples the voltage of the input signal and, ideally, holds that voltage constant while the summing node subtracts out a precise voltage generated by the DAC output current and a load resistor. The output voltage of a typical S/H, however, is nonlinearly dependent on its output current, which changes depending on the output current of the DAC. Consequently, an accurate residue signal cannot be obtained, causing errors in the analog to digital conversion.

For large dynamic range converters, it is therefore necessary to keep the S/H output current nearly constant in order to keep the S/H output voltage a linear representation of the input signal. The conventional solution accomplishes this by using a second complementary output current generated by the DAC to keep the S/H output current constant. This approach, however, requires multiple trim cycles because the value of the complementary DAC current changes whenever the first DAC output current is trimmed. Multiple trim cycles are time consuming and therefore costly, particularly when high accuracies are required for large dynamic range ADCs. When a differential configuration is used, reduced trim time is even more important since two precision DACs need to be trimmed.

Hence, there is a need in the art for an improved system or method for keeping the S/H output current in a subranging ADC constant that requires less trim time than prior art solutions.

### SUMMARY OF THE INVENTION

The need in the art is addressed by the subtraction circuit of the present invention. The novel subtraction circuit includes a first circuit for providing an impedance between an input node and an output node, a second circuit for generating a first current and applying the first current to the output node to produce a desired voltage drop between the input and output nodes, and a third circuit for independently generating a second current relative to the first current and applying the second current to the input node to regulate a current input to the first circuit at the input node. The second and third circuits are implemented using two digital to analog converters, a precision DAC for generating the first current and a non-trimmed “dummy” DAC for generating the second current. In an illustrative embodiment, the subtraction circuit is used in the reconstruction stage of a subranging analog to digital converter to regulate the output current of a S/H circuit.

### BRIEF DESCRIPTION OF THE DRAWINGS

FIG. 1 is a simplified block diagram of a typical subranging analog to digital converter.

FIG. 2 is a simplified block diagram of a subranging ADC using a conventional method for keeping the S/H output current constant.

FIG. 3 is a simplified schematic diagram of an illustrative DAC of conventional design and construction.

FIG. 4 is a simplified schematic diagram of the first stage of the conventional subranging ADC of FIG. 2, showing a single current switch implementation for the DAC.

FIG. 5 is a simplified block diagram of an illustrative embodiment of a subranging ADC designed in accordance with the teachings of the present invention.

FIG. 6 is a simplified block diagram of an illustrative differential implementation of a subranging ADC designed in accordance with the teachings of the present invention.

FIG. 7 is a simplified block diagram of a differential implementation of the subranging ADC of FIG. 2.

FIG. 8 is a simplified diagram of the novel ADC of FIG. 5, illustrating the Early effect error.

FIG. 9 is a simplified schematic of the conventional ADC of FIG. 4, illustrating the parasitic capacitances of the current steering transistors in the prior art.

FIG. 10 is a simplified block diagram of an alternate embodiment of a subranging ADC designed in accordance with the teachings of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

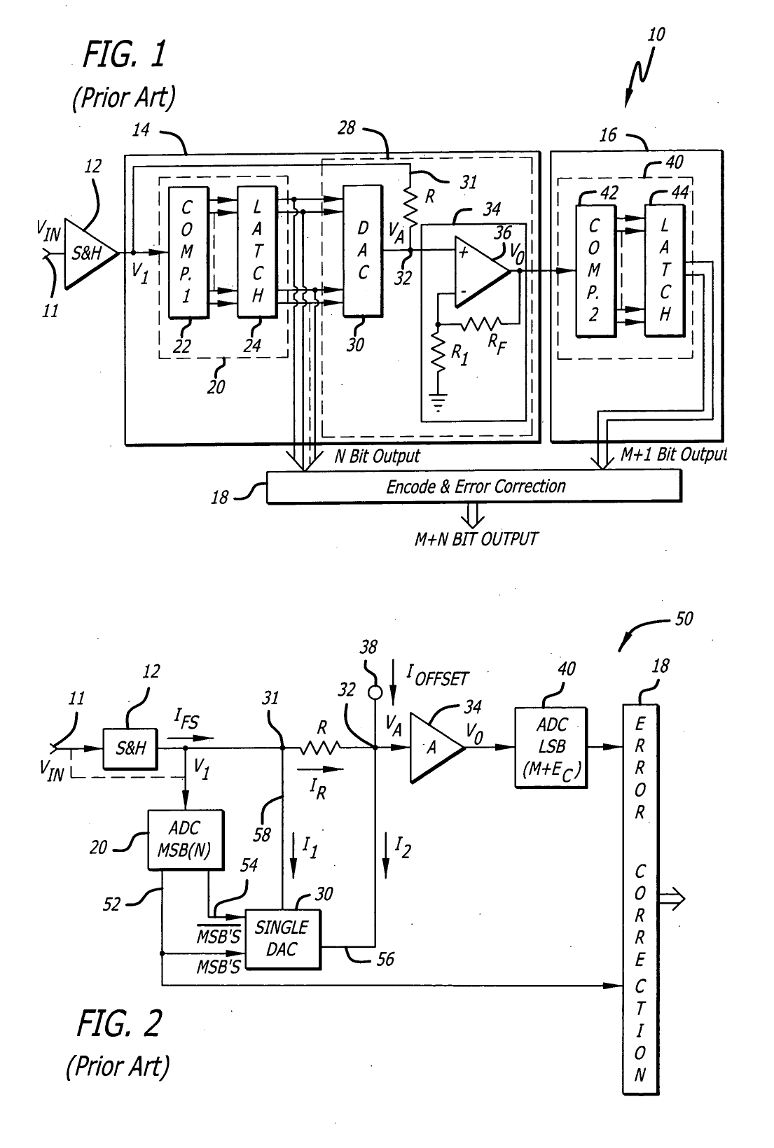

FIG. 1 is a simplified block diagram of a typical subranging analog to digital converter (ADC) 10. The example shown is a two stage ADC 10 having a first stage or “coarse pass” 14, and a second stage or “fine pass” 16. A subranging ADC may have additional stages, similar to the first stage 14, connected in series between the coarse pass 14 and the fine pass 16. An analog input signal V_{IN} is applied to an input terminal 11 connected to a sample and hold (S/H) circuit 12, which outputs a voltage V₁. The sampled voltage V₁ is input to the first subranging stage 14, which includes a first quantizer 20 for digitizing V₁ to N bits and a reconstruction circuit (or subtraction circuit) 28 for subtracting an analog version of the N-bit digital word from the sampled input signal V₁ to generate a residue signal. The residue signal is then digitized by the second stage 16, which includes a second quantizer 40, typically comprised of a comparator bank 42 and latches 44, for generating an M+1 bit digital output (one bit is for error correction) from the residue signal. An error correction circuit 18 combines the N-bit and M+1 bit words to produce an M+N bit digital output representing the original analog input signal. Typical values for N and M are N=5 and M=6.

The first quantizer 20 is typically a low resolution ADC such as a flash converter, which includes a comparator bank 22 and latches 24. The reconstruction circuit 28 includes a digital to analog converter (DAC) 30 for generating an analog version of the output of the quantizer 20; a summing node 32 for subtracting the output of the DAC 30 from the sampled input signal V₁; a resistor R connected between the output node 31 of the S/H 12 and the summing node 32; and an amplifier 34 for amplifying the residue signal generated by the summing node 32. The amplifier 34 typically includes an op amp 36 and two resistors RF and R₁ connected in a feedback configuration.

In the subranging ADC 10 shown in FIG. 1, the full scale input voltage V_{IN} is divided into 2^{N} segments by the 2^{N}−1 comparators of the first comparator bank 22. Then, as appropriate, the summing node 32 subtracts out a current generated by the DAC 30, which typically includes 2^{N}−1 current sources that are switched in or out of the DAC output current depending on the digital word input to the DAC 30. This current is proportional to the instantaneous voltage V₁. As an example, if V₁ is in mid range then half the current sources of the DAC 30 would be on and half would be off. The result of these current sources being turned on or off as a function of the amplitude of V₁ is the positioning of the amplitude of the output voltage V_{O} of the reconstruction circuit 28 to always be within the range of the following bank of comparators 42. The operation of a subranging converter with error correction is well known to those familiar with the art. What is key here is that ideally each DAC current source will be trimmed so that when a comparator in the first comparator bank 22 is crossed and the corresponding DAC switch is turned on, a precise voltage is subtracted from V_{O}.

The voltage V_{A} at the summing node 32 is ideally given by V_{A}=V₁−I_{DAC}R, where I_{DAC} is the output current of the DAC 30 and V₁ is the output voltage of the S/H 12. The output stage of the S/H 12, however, typically includes an emitter follower having a finite output impedance. This causes the voltage V₁ to become nonlinearly dependent on the S/H output current, which changes with the DAC output current I_{DAC}. Consequently, an accurate residue signal cannot be obtained, causing errors in the analog to digital conversion. Therefore, for large dynamic range converters, it is necessary to keep the S/H output current nearly constant in order to keep the S/H output voltage a linear representation of the input signal.

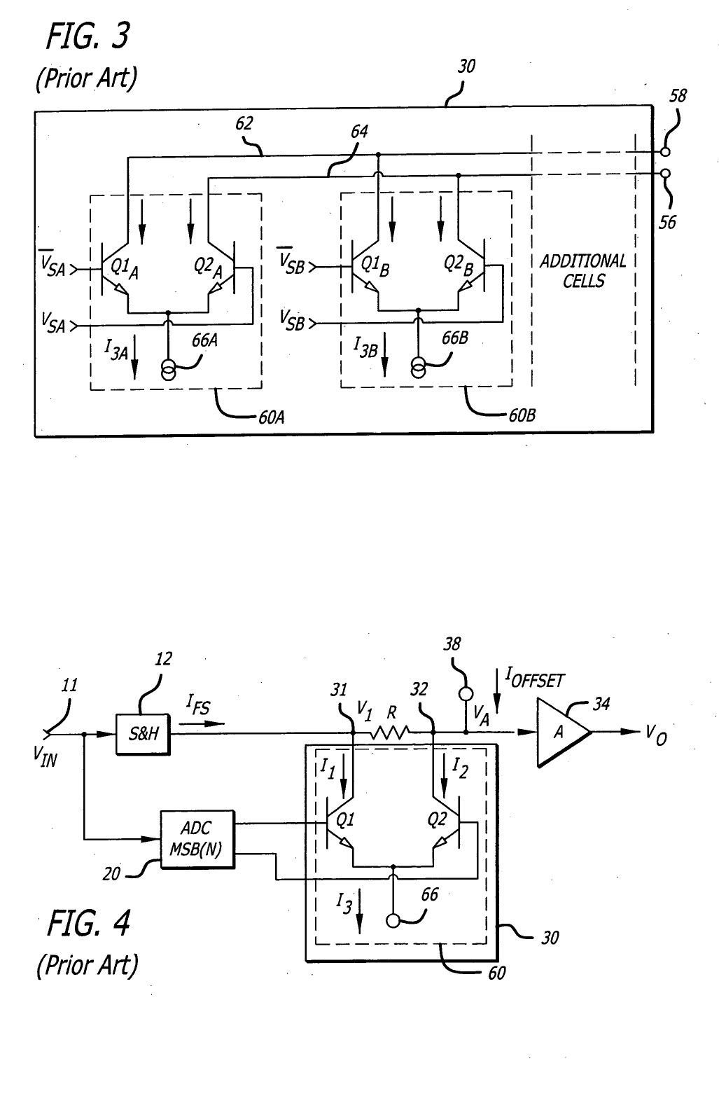

FIG. 2 is a simplified block diagram of a subranging ADC 50 using a conventional method for keeping the S/H output current constant, as discussed more fully in U.S. Pat. No. 5,283,581, entitled “ANALOG VOLTAGE SUBTRACTING CIRCUIT AND AN A/D CONVERTER HAVING THE SUBTRACTING CIRCUIT,” the teachings of which are incorporated herein by reference. In the configuration shown, the first quantizer 20 outputs the MSB signal 52, as well as its complementary signal 54, to the DAC 30. Depending on the circuit implementation, the input to the quantizer 20 may be from the output V₁ of the S/H 12, or V_{IN} from the input terminal 11 (as shown in FIG. 2 by a dotted line). The DAC 30 (shown in more detail in FIGS. 3 and 4) generates two complementary outputs 56 and 58, which are used by the ADC 50 to keep the output current IFS of the S/H 12 constant.

FIG. 3 is a simplified schematic diagram of an illustrative DAC 30 of conventional design and construction. The DAC 30 includes N current steering cells 60, which are: selectively switched into or out of two current summing buses 62 and 64 in response to an N-bit digital input signal (from the quantizer 20). Only two cells 60A and 60B are shown in the figure for simplicity. Each cell includes a differential pair Q1 and Q2, having emitters connected in common to a current source 66, and collectors coupled to the first and second buses 62 and 64, respectively. (Components in the first cell 60A are labeled with a subscript A, and components in the second cell 60B are labeled with a subscript B). The base of Q2 is coupled to a signal V_{S}, representing one bit of the N-bit digital input, and the base of Q1 is coupled to its complement \overline{V}_{S}. As shown in FIG. 3, the first cell 60A is controlled by a signal V_{SA}, representing the most significant bit (MSB) of the N-bit digital word, and the second cell 60B is controlled by a signal V_{SB}, representing the next MSB. The DAC 30 can therefore be configured to generate two complementary output signals 58 and 56 from the first and second buses 62 and 64, respectively.

As shown in FIG. 2, the first DAC output 56 is connected to the summing node 32, drawing a current I₂. The second DAC output 58 is connected to the other end of the load resistor R, at the output node 31 of the S/H 12, drawing a current I₁. The ADC 50 may also include a current source 38 for coupling an offset current I_{OFFSET} to the summing node 32. The offset current I_{OFFSET} allows the output voltage V_{O} to be adjusted to a desired DC offset, such as V_{O}=0 V when V_{IN}=0 V.

FIG. 4 is a simplified schematic diagram of the first stage of the conventional subranging ADC 50 of FIG. 2, showing a single current switch implementation for the DAC 30. Only one current switching cell 60 is shown for simplicity; in practice, the DAC 30 will include several current switching cells. The collector of Q1 is coupled to the S/H output node 31, drawing a current I₁, and the collector of Q2 is coupled to the summing node 32, drawing a current I₂. This conventional implementation utilizes the second collector in the DAC current switching cells to supply a complementary current, which is used to hold the S/H output current I_{FS} nearly constant so that the S/H output voltage V₁ is a linear function of the input V_{IN}.

By connecting the collector of Q1 to the S/H output node 31, the current is shifted from one side of R to the other (since I₁ and I₂ are complementary currents), keeping the S/H output current I_{FS} to approximately 2V_{IN full scale}/2^{N}×R. This will meet the objective to keep V₁ a linear-function of V_{IN}. However, a problem arises with this implementation. Since I₁ and I₂ are derived from the same current source 66, when I₂ is trimmed (the current source 66 is actually trimmed), then I₁ will also change. Because of this dependence of I₁ on I₂, multiple trim cycles are required to achieve an optimum trim value for I₂.

A simple analysis will help to illustrate this problem. First, recognize that there is a finite output impedance r_{O} associated with the S/H 12. The S/H output voltage V₁ is therefore given by V₁=V_{IN}−r_{O}I_{FS}. Two end point conditions need to be satisfied. First, for V_{IN}=0, I₁ on and I₂ off, V_{O} should be 0 V. Second, for V_{IN}=ΔV_{IN}, I₁ off and I₂ on, V_{O} should be 0 V. These conditions are met by trimming I_{OFFSET} and I₂.

For the first condition, V_{O}=V_{IN}−r_{O}_{I}_{FS}+RI_{OFFSET} and I_{FS}=I₁−I_{OFFSET}. This gives V_{O}=V_{IN}−r_{O}(I₁−I_{OFFSET})+RI_{OFFSET}=V_{IN}−r_{O}I₁+(r_{O}+R)I_{OFFSET}. Substituting V_{O}=V_{IN}=0 results in:
I_{OFFSET}=r_{O}I₁/(r_{O}+R). [1]

For the second condition, V_{O}=V_{IN}−(r_{O}+R)I_{FS} and I_{FS}=I₂−I_{OFFSET}. This gives V_{O}=V_{IN}−(r_{O}+R)(I₂−I_{OFFSET}). Substituting V_{O}=0 and V_{IN}=ΔV_{IN} results in:
I₂=ΔV_{IN}/(r_{O}+R)+I_{OFFSET.} [2]

Substituting Eqn. 1 into Eqn. 2 gives:
I₂=ΔV_{IN}/(r_{O}+R)+r_{O}I₁/(r_{O}+R) [3]

Letting I₁=I₂ results in I₂=ΔV_{IN}/R, an exact solution.

While this analysis provides us with an exact solution, an example will show that it takes multiple iterations to approach it in practice. Because of process variations, the DAC cells are designed to higher than optimum current values, and then trimmed until accuracy requirements are met. So, as an example, let I₃=I₁=1.2 mA, r_{O}=25 Ω, R=64 Ω, and ΔV_{IN}=64 mV.

In the first step of the trimming process, in order to set V_{O}=0 for V_{IN}=0, the offset current I_{OFFSET} is set to I_{OFFSET}=r_{O}I₁/(r_{O}+R)=0.000337079 (from Eqn. 1).

In the second step, in order to set V_{O}=0 for V_{IN}=64 mV, the DAC current I₂ is trimmed (by trimming I₃ from the current source 66) to I₂=ΔV_{IN}/(r_{O}+R)+I_{OFFSET}=0.001056180 (from Eqn. 2).

Trimming I₃, however, also changes the value of I₁. The value of V_{O} therefore needs to be rechecked for V_{IN}=0, the first condition. Substituting I_{OFFSET}=0.000337079 and I₁=I₂ =0.001056180, gives V_{O}=V_{IN}−r_{O}I₁+(r_{O}+R)I_{OFFSET}=0.003595531. V_{O} is therefore no longer equal to 0, so the circuit must be re-trimmed.

During the second iteration, the first step is repeated using I₁ with a new value of 0.00105618, setting the offset current to I_{OFFSET}=r_{O}I₁/(r_{O}+R)=0.00029668 (from Eqn. 1).

Repeating the second step using the new I_{OFFSET}, the DAC current I₂ is trimmed (by trimming I₃ from the current source 66) to I₂=ΔV_{IN}/(r_{O}+R)+I_{OFFSET}=0.001015781 (from Eqn. 2).

Rechecking V_{O} for V_{IN}=0 again, gives V_{O}=V_{IN}−r_{O}I₁+(r_{O}+R)I_{OFFSET}=0.001009995. V_{O} is getting closer to 0 V, but more iterations will be required if the ADC is to achieve the accuracy required for a large dynamic range ADC.

One important point needs to be made here. The above example was simplified (only one DAC switch was used) to clarify the problem and process. When a real DAC is used, one with multiple switches and current sources (a typical DAC includes 31 current sources), the trim scenario would be to set I_{OFFSET}, trim all of the current sources, then re-trim I_{OFFSET}, re-trim all 31 current sources, and so on until the desired accuracy is achieved. Having to re-trim all 31 current sources and I_{OFFSET} multiple times to get to the required accuracy is very time consuming and therefore, costly.

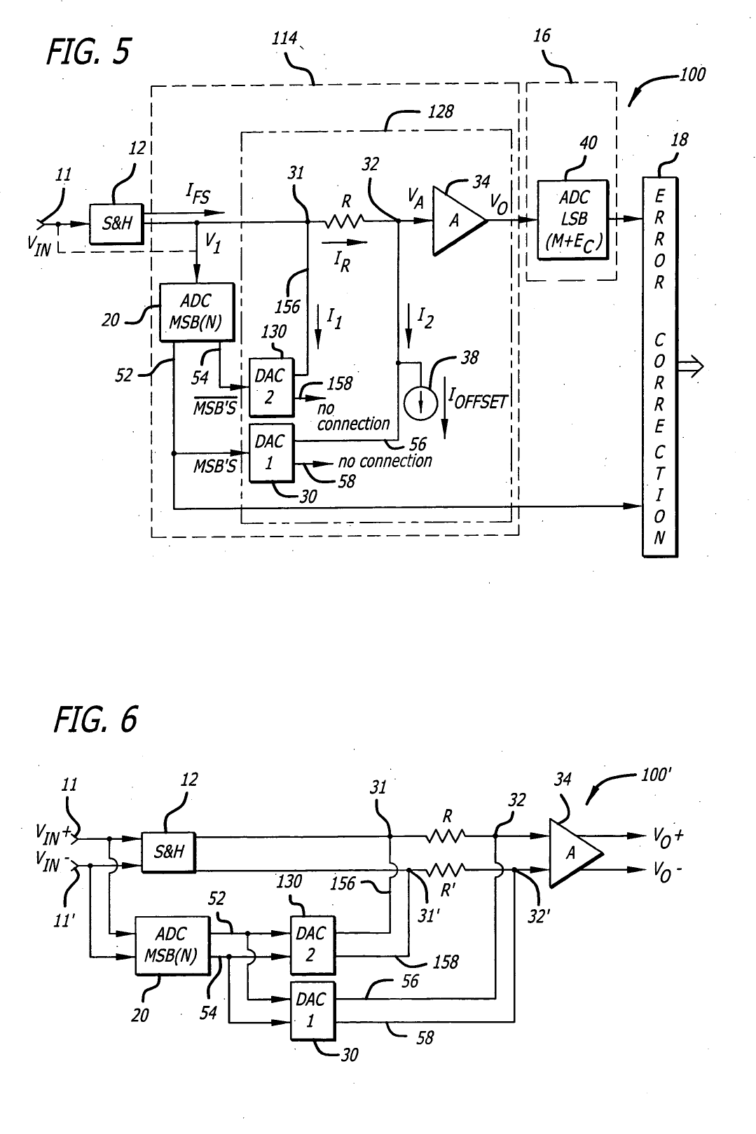

FIG. 5 is a simplified block diagram of an illustrative embodiment of a subranging ADC 100 designed in accordance with the teachings of the present invention. The illustrative embodiment shown is a two-stage ADC 100 having a: first stage or “coarse pass” 114, and a second stage or “fine pass” 16. The invention, however, is not limited thereto. The subranging ADC 100 may have any number of additional stages, similar to the first stage 114, connected in series between the coarse pass 14 and the fine pass 16.

An analog input signal V_{IN} is applied to an input terminal 11 connected to a sample and hold (S/H) circuit 12, which outputs a voltage V₁. The sampled voltage V₁ is input to the first subranging stage 114, which includes a first quantizer 20 for digitizing V₁ to its N most significant bits and a novel reconstruction circuit 128 for subtracting an analog version of the N-bit digital word from the sampled input signal V₁ to generate a residue signal. The residue signal is then digitized by the second stage 16, which includes a second quantizer 40 for generating an M+1 bit digital output (one bit is for error correction) from the residue signal. An error correction circuit 18 combines the N-bit and M+1 bit words to produce an M+N bit digital output representing the original analog input signal.

Depending on the circuit implementation, the input to the quantizer 20 may be the S/H output voltage V₁, or the input voltage V_{IN} from the input terminal 11(as shown by a dotted line). In addition, for an ADC having more than two stages, each subranging stage may be driven by a S/H circuit. The teachings of the present invention may be applied to the S/H of each subranging stage to keep each S/H output current constant.

The novel reconstruction circuit 128 includes two DACs 30 and 130. As with the prior art implementations, the first DAC 30 generates a current I₂ from the MSB output 52 of the quantizer 20 and applies the current I₂ to a summing node 32, generating a desired voltage drop across a resistor R and a residue voltage V_{A} at the summing node 32. The resistor R is connected between the output node 31 of the S/H 12 and the summing node 32. In accordance with the teachings of the present invention, the reconstruction circuit 128 also includes a second “dummy” DAC 130 adapted to output a complementary current I₁, generated independent of I₂, and apply the current I₁ to the S/H output node 31, such that the S/H output current I_{FS} is held approximately constant. The reconstruction circuit 128 may also include a current source 38 for coupling an offset current I_{OFFSET} to the summing node 32, and an amplifier 34 for amplifying the voltage V_{A} at the summing node 32 and outputting a voltage V_{O} to the second quantizer 40.

In the illustrative embodiment, the quantizer 20 outputs the MSB signal 52, as well as its complementary signal 54. The MSB signal 52 is applied to the first DAC 30, while the complementary signal is applied to the second DAC 130. As discussed above, each DAC may be configured to output two complementary signals. In the single-ended implementation shown in FIG. 5, the first output 56 of the DAC 30 is applied to the summing node 32, and the second complementary output 58 is not used (connected to ground). The first output 156 of the second DAC 130 is applied to the S/H output node 31, and the second complementary output 158 is not used. The secondary DAC outputs 58 and 158 may be used in a differential implementation, as shown in FIG. 6.

Thus, the present invention holds the S/H output current I_{FS} constant by utilizing complementary currents generated by two separate DACs. The first DAC 30 is a precision DAC, trimmed to accurately add or subtract I₂ from the summing node 32 to produce an accurate residue signal V_{A}. The second “dummy” DAC 130 is used to provide the complementary current I₁ used to keep the S/H output current I_{FS} constant. The current I₁ is therefore independent of I₂. When the first DAC 30 is trimmed, there is no impact on the second DAC 130 or its output current I₁, so when the initial condition is rechecked, I_{OFFSET} is still correct to return V_{O} to 0 V. Therefore, only one trim cycle is required, saving the time and cost associated with the multiple trim cycles required by the prior art.

The first DAC 30 should be a precision DAC, trimmed to accurately add or subtract I₂ from the summing node 32 so that V_{A} is never greater than 2V_{IN full scale}/2^{N}. The second DAC 130, however, does not need to be a precision DAC and does not require trimming. The output current I₁ of the second DAC-130 changes as the complement of the output current I₂ of the first DAC 30. Thus, when I₂ increases a ΔI₂ step, I₁ decreases a ΔI₁ step, where ΔI₁ and ΔI₂ are almost identical, thereby always keeping the change in the S/H output current I_{FS} equal to or less than +V_{IN full scale}/(2^{N}×R). This keeps the S/H output voltage V₁ linear. The current change ΔI₁ does not need to be exactly equal to ΔI₂ for this invention to work. The dummy DAC 130 therefore does not need to be a precision DAC. This leads to an additional benefit when the ADC is implemented differentially.

FIG. 6 is a simplified block diagram of an illustrative differential implementation of a subranging ADC 100′ designed in accordance with the teachings of the present invention. Only the first stage of the ADC 100′ is shown for simplicity. Differential input signals V_{IN}⁺ and V_{IN}⁻ are applied to input terminals 11 and 11′, and input to a S/H circuit 12 and a quantizer 20. The S/H differential outputs 31 and 31′ are each connected to a summing node 32 and 32′, respectively, through a resistor R and R′, respectively, where the resistors R and R′ are matched. The quantizer differential outputs 52 and 54 are applied to a first DAC 30 and a dummy DAC 130. The outputs 56 and 58 of the first DAC 30 are applied to the summing nodes 32 and 32′, respectively. The outputs 156 and 158 of the dummy DAC 130 are applied to the S/H output nodes 31 and 31′, respectively. The signals at the summing nodes 32 and 32′ are input to an amplifier 34, which outputs differential signals V_{O}⁺ and V_{O}⁻ to the second stage of the converter (not shown).

When the invention is used in a differential configuration, the same two DACs as described for FIG. 5 are used, one precision DAC 30 and one non-trimmed dummy DAC 130, but the previously unused DAC outputs 58 and 158 are tied to the second leg of the differential circuit. The same argument above applies to this circuit. The output currents from the precision DAC 30 and the dummy DAC 130 are still independent of each other, so when the first DAC 30 is trimmed, the outputs from the dummy DAC 130 remain unchanged, and only one trim cycle is needed. The dummy DAC 130, as in FIG. 5, is a simple DAC configuration that requires no trimming. It is designed around the nominal expected values of the final trim currents in the first DAC 30.

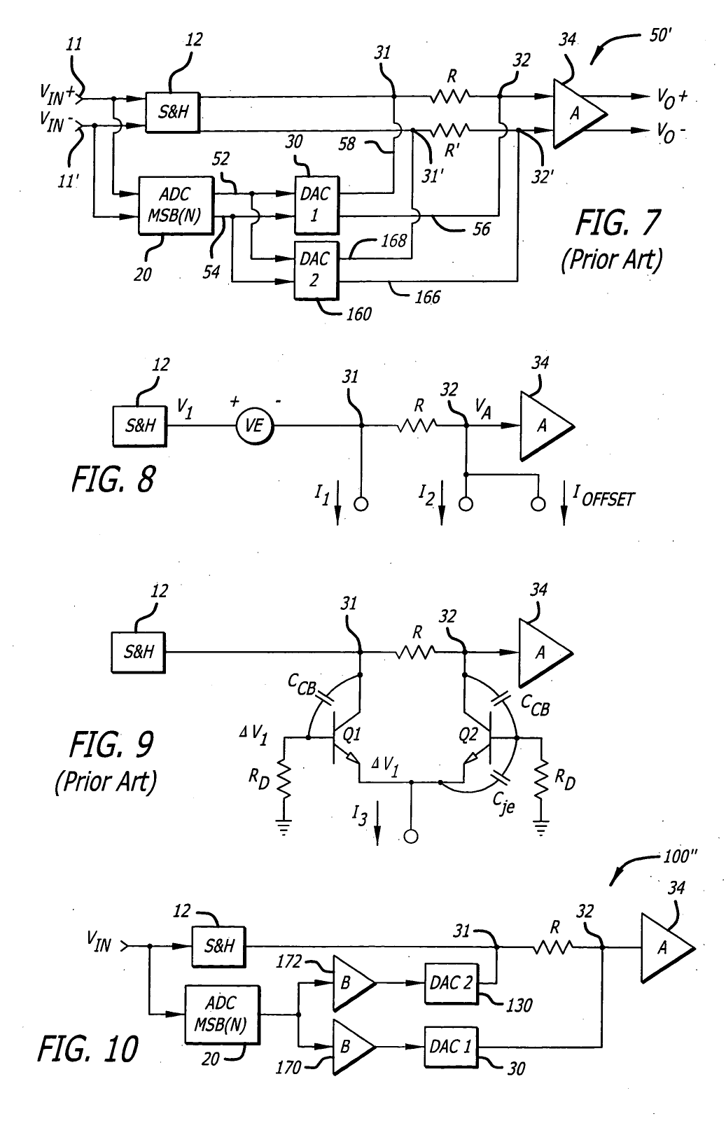

In contrast, FIG. 7 is a simplified block diagram of a differential implementation of the subranging ADC 50′ of FIG. 2. Only the first stage of the ADC 50′ is shown for simplicity. The conventional ADC 50′ shown is similar to the ADC 100′ of FIG. 6, except it requires two precision DACs 30 and 160. The first DAC 30 is connected as shown in FIG. 2 for one leg of the differential circuit, having a first output 56 connected to the summing node 32 and a second complementary output 58 connected to the S/H output node 31. The second DAC 160 is connected in a similar manner to the second differential leg, having a first output 166 connected to the summing node 32′ and a second complementary output 168 connected to the S/H output node 31′.

In the conventional implementation, both DACs must be precision DACs. In the novel implementation of the present invention, only one DAC needs to be a precision DAC. The second “dummy” DAC does not need to be trimmed. A precision DAC, due to its requirement to be accurately trimmed, requires significantly greater die area to implement. Therefore, the present invention requires much less trim time in either single-ended or differential implementations, and, additionally, less die area when used differentially.

One other subject should be mentioned although it does not change the outcomes of any previous arguments and is offered here only for completeness. In the simplified analysis given above for the conventional ADC of FIG. 4, the Early effect on transistor Q1 (and the other switching transistors in parallel with it) was not included in the analysis. This was done for clarity and does not, in any way, change the conclusions reached by that analysis.

The Early effect does not impact the ADC implementation of the present invention. FIG. 8 is a simplified diagram of the novel ADC of FIG. 5, illustrating the Early effect error. The result of the Early effect error can be considered an error voltage source V_{E}, connected between the S/H 12 and the node 31 connected to the output current I₁ (from the dummy DAC 130). The Early effect is negated, first as I_{OFFSET} is trimmed, and then again as the error voltage V_{E} is trimmed out as I₂ is trimmed at each step increment. Therefore, the Early effect has no deleterious impact on the performance of the invention as it is implemented.

In the preferred embodiment, the common mode voltage and the output voltage range of operation are set so that I_{OFFSET} is a current sink. This is done so that the current source (sink) can be implemented with NPN transistors. Settling time is critical in high speed ADCs and NPN current sources settle considerably faster than those implemented with PNP transistors. Other process technologies can be used, however, without departing from the scope of the present teachings.

Another feature of the present invention is that parasitic capacitive coupling from the output of the S/H 12 to the summing node 32 of the amplifier 34 can be avoided. FIG. 9 is a simplified schematic of the conventional ADC of FIG. 4, illustrating the parasitic capacitances of the current steering transistors Q1, Q2 in the prior art. As the S/H 12 switches from hold to sample, the S/H output voltage can slew the full scale voltage +/−V_{full scale}. This voltage can be coupled to the summing node 32. As shown in FIG. 9, the voltage at the S/H output node 31 couples through the collector-base capacitance C_{CB} of Q1 to the base of Q1, passing through to the emitter of Q1, and then couples through the base-emitter capacitance Cⱼₑ and the collector-base capacitance C_{CB} of Q2, to the summing node 32. Note that only one current steering cell, is shown. The parasitic capacitive coupling occurs for all the current steering cells. This coupling, in very large dynamic range ADCs, results in extended settling time of the amplifier 34 and the following circuitry. The parasitic coupling can be eliminated in the present invention, as illustrated in FIG. 10.

FIG. 10 is a simplified block diagram of an alternate embodiment of a subranging ADC 100″ designed in accordance with the teachings of the present invention. Only the first stage of the subranging ADC 100″ is shown for simplicity. The illustrative ADC 100″ shown is a single-ended implementation similar to that of FIG. 5, with the addition of two buffer circuits 170 and 172, one buffer 170 connected between the quantizer 20 and the DAC 30, and the other buffer 172 connected between the quantizer 20 and the dummy DAC 130. The buffer drivers 170 and 172 are isolation amplifiers designed to eliminate any reverse capacitive feedthrough from the DACs 30 and 130, respectively. The buffer drivers 170 and 172 therefore isolate the first DAC 30 from the second DAC 130, eliminating the parasitic coupling since there is no path from the output of the S/H 12 to the input of the amplifier 34 except through the isolating buffers 170 and 172. The reverse isolation of the buffer circuits 170 and 172 reduces the feedthrough several orders of magnitude.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

1. A subtraction circuit comprising:
a first circuit for providing an impedance between an input node and an output node;
first means for generating a first current and applying said first current to said output node to produce a desired voltage drop between said input and output nodes; and
second means for independently generating a second current relative to said first current and applying said second current to said input node to regulate an input current input to said first circuit at said input node.

2. The invention of claim 1 wherein changes in said second current are approximately complementary to changes in said first current.

3. The invention of claim 1 wherein said first means includes a first digital to analog converter adapted to receive a digital input signal and in accordance therewith output said first current.

4. The invention of claim 3 wherein said second means includes a second digital to analog converter adapted to receive said digital input signal, or a signal complementary to said digital input signal, and in accordance therewith output said second current.

5. The invention of claim 3 wherein said subtraction circuit further includes third means for reducing any reverse capacitive feedthrough from said first digital to analog converter.

6. The invention of claim 5 wherein said third means includes a first buffer circuit coupled to the input of said first digital to analog converter.

7. The invention of claim 4 wherein said subtraction circuit further includes fourth means for reducing any reverse capacitive feedthrough from said second digital to analog converter.

8. The invention of claim 7 wherein said fourth means includes a second buffer circuit coupled to the input of said second digital to analog converter.

9. The invention of claim 4 wherein said second digital to analog converter is a non-trimmed digital to analog converter.

10. The invention of claim 3 wherein said first digital to analog converter is a precision digital to analog converter.

11. The invention of claim 1 wherein said subtraction circuit is implemented differentially.

12. The invention of claim 1 wherein said subtraction circuit further includes a second circuit for providing an impedance between a second input node and a second output node.

13. The invention of claim 12 wherein said first means is further adapted to generate a third current and apply said third current to said second output node to produce a desired voltage drop between said second input node and said second output node.

14. The invention of claim 13 wherein said second means is further adapted to independently generate a fourth current relative to said third current and apply said fourth current to said second input node to regulate a second input current input to said second circuit at said second input node.

15. The invention of claim 14 wherein changes in said fourth current are approximately complementary to changes in said third current.

16. The invention of claim 14 wherein said first means includes a first digital to analog converter adapted to receive a digital input signal and in accordance therewith output said first and third currents.

17. The invention of claim 16 wherein said second means includes a second digital to analog converter adapted to receive said digital input signal and in accordance therewith output said second and fourth currents.

18. The invention of claim 1 wherein said subtraction circuit further includes fifth means for applying an input voltage to said input node.

19. The invention of claim 18 wherein said fifth means includes a sample and hold circuit.

20. The invention of claim 1 wherein said first circuit includes a resistor connected between said input and output nodes.

21. The invention of claim 12 wherein said second circuit includes a second resistor connected between said second input node and said second output node.

22. A subtraction circuit comprising:
a first circuit for providing an impedance between an input node and an output node;
a first digital to analog converter adapted to receive a digital input signal and in accordance therewith generate a first current and apply said first current to said output node to produce a desired voltage drop between said input and output nodes; and
a second digital to analog converter adapted to receive said digital input signal, or a signal complementary to said digital input signal, and in accordance therewith independently generate a second current relative to said first current and apply said second current to said input node to regulate an input current input to said first circuit at said input node.

23. The invention of claim 22 wherein changes in said second current are approximately complementary to changes in said first current.

24. The invention of claim 22 wherein said subtraction circuit further includes a first buffer circuit coupled to the input of said first digital to analog converter for reducing any reverse capacitive feedthrough.

25. The invention of claim 22 wherein said subtraction circuit further includes a second buffer circuit coupled to the input of said second digital to analog converter for reducing any reverse capacitive feedthrough.

26. The invention of claim 22 wherein said second digital to analog converter is a non-trimmed digital to analog converter.

27. The invention of claim 22 wherein said first digital to analog converter is a precision digital to analog converter.

28. An analog to digital converter comprising:
a. sample and hold circuit adapted to receive an analog input signal and output a sampled voltage, and
a subranging stage including a quantizer adapted to digitize said input signal to generate a digital signal and a reconstruction circuit, said reconstruction circuit comprising:
a first circuit adapted to receive said sampled voltage at an input node and provide an impedance between said input node and an output node;
a first digital to analog converter adapted to receive said digital signal and in accordance therewith generate a first current and apply said first current to said output node to produce a desired voltage drop between said input and output nodes to generate a residue signal at said output node; and
a second digital to analog converter adapted to receive said digital signal, or a signal complementary to said digital signal, and in accordance therewith independently generate a second current relative to said first current and apply said second current to said input node to regulate an input current input to said first circuit at said input node.

29. The invention of claim 28 wherein changes in said second current are approximately complementary to changes in said first current.

30. The invention of claim 28 wherein said reconstruction circuit further includes a first buffer circuit coupled to the input of said first digital to analog converter for reducing any reverse capacitive feedthrough.

31. The invention of claim 28 wherein said reconstruction circuit further includes a second buffer circuit coupled to the input of said second digital to analog converter for reducing any reverse capacitive feedthrough.

32. The invention of claim 2-8 wherein said second digital to analog converter is a non-trimmed digital to analog converter.

33. The invention of claim 28 wherein said first digital to analog converter is a precision digital to analog converter.

34. A method for regulating a current input to a subtraction circuit including the steps of:
applying an input voltage to an input node of a first circuit adapted to provide an impedance between said input node and an output node;
generating a first current and applying said first current to said output node to generate a desired voltage drop between said input and output nodes; and
generating a second current independent of said first current and applying said second current to said input node to regulate a current input to said first circuit at said input node.
